(19) United States
(12) Patent Application Publication
(10) Pub. No.: US 2019/0146065 A1
(43) Pub. Date: May 16, 2019

(54) COMPACT LASER SENSOR

(71) Applicant: KONINKLIJKE PHILIPS N.V., EINDHOVEN (NL)

(72) Inventors: PETRUS THEODORUS JUTTE, WEERT (NL); JOHANNES HENDRIKUS MARIA SPRUIT, WAALRE (NL); ALEXANDER MARC VAN DER LEE, VENLO (NL)

(21) Appl. No.: 16/300,117

(22) PCT Filed: May 9, 2017
(86) PCT No.: PCT/EP2017/060967

§ 371 Date: Nov. 9, 2018

(30) Foreign Application Priority Data
May 19, 2016 (EP) 16170373.1

(51) Int. Cl. G01S 7/481; G01S 17/58; G01S 17/95; G01S 7/491

(52) U.S. Cl. CPC G01S 7/4812; G01S 7/4916; G01S 17/95; G01S 17/58

(57) ABSTRACT

The invention describes a laser sensor module. The laser sensor module comprises at least one laser (100) being adapted to emit a measurement beam (111). The laser sensor module further comprises a compact optical device (150) being arranged to focus the measurement beam (111) to a focus region (115). The compact optical device comprises an optical carrier (154) with a convex mirror surface (152) on one side and a concave mirror surface (156) on a second opposite side, wherein the concave mirror surface (156) comprises an entrance surface through which the measurement beam (111) can enter the optical carrier (154). The compact optical device (150) is arranged such that the measurement beam (111) entering the optical carrier is reflected and diverged by means of the convex mirror surface (152) to the concave mirror surface (156). The concave mirror surface (156) is arranged to focus the measurement beam (111) received from the convex mirror surface (152) to a focus region (115). The laser sensor module further comprises at least one detector (120) which is adapted to determine at least a self-mixing interference signal of a first optical wave within a laser cavity of the laser (100).The invention further describes a laser sensor (180) comprising such a laser sensor module. The invention finally describes devices like a mobile communication device comprising the laser sensor (180) or the laser sensor module.

### FIELD OF THE INVENTION

The invention relates to a laser sensor module using self-mixing interference and a laser sensor especially a laser sensor comprising the laser sensor module. The invention further relates to a mobile communication device comprising such a laser sensor or laser sensor module.

### BACKGROUND OF THE INVENTION

CN102564909 A discloses a laser self-mixing multi-physical parameter measurement method and a laser self-mixing multi-physical parameter measurement device for atmospheric particulate matter. The laser self-mixing multi-physical parameter measurement device comprises a microchip laser, a collimating lens, a beam splitter, converging lenses, a photodetector, an amplifier, a data acquisition card and a spectrum analyzer. The described devices are complicated and expensive.

### SUMMARY OF THE INVENTION

It is an object of the present invention to provide compact laser sensor module especially for particle density detection. The invention is defined by the independent claims. The dependent claims define advantageous embodiments.

According to a first aspect a laser sensor module is presented. The laser sensor module comprises:
at least one laser being adapted to emit a measurement beam,
a compact optical device being arranged to focus the measurement beam to a focus region, wherein the compact optical device comprises an optical carrier with a convex mirror surface on one side and a concave mirror surface on a second opposite side, wherein the concave mirror surface comprises or surrounds an entrance surface through which the measurement beam can enter the optical carrier, wherein the compact optical device is arranged such that the measurement beam entering the optical carrier is reflected and diverged by means of the convex mirror surface to the concave mirror surface, and wherein the concave mirror surface is arranged to focus the measurement beam received from the convex mirror surface to a focus region, and
one detector being adapted to determine at least a self-mixing interference signal of a first optical wave within a laser cavity of the laser.

Laser sensors based on self-mixing interference may be used for a multitude of detection applications. Presence, distance, velocity and direction of movement of an object passing the focus region of the measurement beam emitted by the laser may be detected. The measurement beam is reflected by the object and least part of the reflected measurement beam re-enters the laser cavity of the laser. Interference of the re-entering laser light with the optical standing wave within the laser cavity causes a variation of the standing wave which is called self-mixing interference. The self-mixing interference can be measured, for example, by means of a detector like a photo diode. Conventional lenses which may be used to focus the measurement beam may cause rather big laser sensor modules. The compact optical device enables a very compact laser sensor module which may be much smaller than laser sensor modules focusing the measurement beam by means of a conventional lens.

The compact optical device comprises an optical carrier with a convex mirror surface on one side and a concave mirror surface on the opposite side. The concave mirror surface comprises an entrance window or entrance surface through which light can enter the optical carrier. The entrance surface is preferably circular around the center of the concave mirror surface. Light entering the optical carrier via the entrance window is reflected and diverged by means of the convex mirror surface to the concave mirror surface. The concave mirror surface is arranged to focus the light received from the convex mirror surface to a focus region which is on the opposite side of the compact optical device relative to the laser. The compact optical device may help to reduce the size of the laser sensor module by decreasing a distance between the laser and the exit surface of the lens. The path of the laser light is folded and at the same time focused by means of the mirror surfaces. The compactness may enable or support integration of such laser sensor modules and corresponding applications in small devices especially in mobile devices like mobile communication devices. The mirror surfaces and the entrance surface are preferably arranged circular symmetric around an optical axis defined by the measurement beam emitted by the laser.

The compact optical device is characterized by a coupling numerical aperture. The coupling numerical aperture is the numerical aperture of the compact optical device on the laser side. The coupling numerical aperture NA of the compact optical device may be in the range 0.15<NA<0.30 preferably in the range of 0.18<NA<0.25. The coupling numerical aperture in the range of 0.2 results a diverging beam towards the focusing concave mirror surface comprised by the compact optical device. The coupling NA is depending on the laser beam angle. Laser beam angle can vary between laser types.

The laser sensor module may comprise two, three, four or more lasers (e.g. array of Vertical Cavity Surface Emitting Lasers (VCSEL) arranged on one common semiconductor chip).

The laser sensor module may further comprise a focusing device. The focusing device may be arranged to converge the measurement beam to the convex mirror surface of the compact optical device.

The compact optical device may have the disadvantage that the convex mirror surface shadows or blocks a part of the measurement beam and especially laser light reflected by an object. The beam blocking may cause reduction or even disturbance of the self-mixing interference signal especially by reducing the intensity of the laser light back reflected by the object. The laser light of the measurement beam is converged by means of the focusing device (preferably a convex lens, another possibility is a Fresnel lens or a diffractive lens.) such that essentially parallel light beams are received at the convex mirror surface. The size of the convex mirror surface may thus be smaller in comparison to the size without the focusing device. Furthermore, a curvature of the convex mirror surface may be bigger in comparison to the curvature without the focusing device such that essentially the whole concave mirror surface may be illuminated by means of the measurement beam reflected by the convex mirror surface. The size or area covered by the convex mirror surface may be arranged such that beam blocking is minimized. The area covered by the convex mirror surface may be the same as an area of the entrance surface of the compact optical device and aligned with the entrance surface along the optical axis defined by the laser light entering the entrance surface. The focusing device may therefore enable a more compact laser sensor module with high detection sensitivity.

The focusing device may be positioned in the entrance surface of the compact optical device. The entrance surface may be refractive and arranged such that the measurement beam emitted by the laser is converged as described above. Integration of the focusing device in the compact optical device may further decrease the size of the laser sensor module because there is essentially no distance between the focusing device and the compact optical device. The focusing device may consist of the same material as the optical carrier. The focusing device may alternatively comprise a different optical material, for example, with a higher refractive index in order to increase the refractive power. Choosing different materials for the optical carrier and the focusing device may be used to further decrease the distance between the laser and the compact optical device and therefore the size of the laser sensor module.

The concave mirror surface is arranged to focus the measurement beam to the focus region. The laser, the focusing device, the convex mirror surface and the concave mirror surface are arranged to define an exit beam area of the compact optical device in a plane in which the convex mirror surface is positioned. The laser, the focusing device and the convex mirror surface may be arranged such that more than 95% of the measurement beam is reflected to the concave mirror surface. The divergences angle of the laser light emitted by the laser, the distance between the laser and the focusing device, the distance between the focusing device and the entrance window, the size of the entrance window, the distance between the entrance window and the convex mirror surface, the curvature of the convex mirror surface and the curvature of the concave mirror surface are arranged such that more than 85% preferably more than 90% and most preferred more than 95% of the emitted laser light of the measurement beam is focused to the focus region. The convex mirror surface may cover less than 10%, preferably less than 7% and even more preferred less than 5% of the exit beam area such that blocking especially of backscattered light of the measurement beam is reduced The laser may comprise a micro-optical device arranged to adapt the divergence angle such that a cross-section of the measurement beam is essentially circular symmetric. The laser may be, for example, an edge emitting semiconductor laser. Circular symmetry of the measurement beam in combination with the compact optical device may increase the portion of the laser light focused to the focus region and the intensity of the back reflected or backscattered light of the measurement beam. It may thus be beneficial that the laser is a VCSEL emitting a circular symmetric measurement beam.

The entrance surface and the concave mirror surface are approximately arranged in an entrance plane (neglecting the curvature of the concave mirror surface and optionally the entrance surface). Furthermore, the convex mirror surface approximately defines a plane if the curvature of the convex mirror surface is neglected. The plane may, for example, be the plane comprising the edge of the convex mirror surface. The plane may comprise one side of the optical carrier. The plane may comprise an exit surface of the compact optical device at which the measurement beam leaves the compact optical device.

The curvature of the convex mirror surface and the curvature of the concave mirror surface may be arranged such that a distance d between the convex mirror surface and the concave mirror surface is a range between 1 mm and 2 mm (distance between a virtual point of the concave mirror surface and a point of the convex mirror surface on the optical axis of the measurement beam). Adaption of one or both curvatures may be used to further decrease the size of the laser sensor module.

The laser sensor module may comprise an optical redirection device. The optical redirection device may be arranged to dynamically change a position of the focus region. The optical redirection device may be a movable mirror, especially a switchable mirror like a MEMS mirror.

The laser sensor module may comprise a detection window. The detection window may be arranged such that the measurement beam reaches the focus region after passing the detection window. The detection window may be arranged to protect the laser sensor module especially the compact optical device. The detection window may be arranged between the compact optical device and the focus region. This configuration may be beneficial if an optical redirection device is comprised by the laser sensor module. The detection window may alternatively be at least partially arranged between the convex mirror surface and the concave mirror surface. The optical carrier may for example comprise the detection window. The convex mirror surface may be embedded in the optical carrier such that the exit window is arranged between the plane defined by the convex mirror surface and the focus region. Furthermore, the detection window may be attached to the optical carrier of the compact optical device. The detection window may for example comprise a scratch-resistant material which may be glued to the optical carrier.

According to a further aspect a laser sensor is provided. The laser sensor comprises the laser sensor module according to any embodiment as described above. The laser sensor further comprises an evaluator. The evaluator may be adapted to receive detection signals generated by the detector in reaction to the determined self-mixing interference signals. The evaluator may be further adapted to determine at least one of a velocity component, distance or direction of movement of an object in the focus region. The evaluator may especially be adapted to determine a particle density based on the received detection signals in a predetermined time period. The particle density may be determined by determining number of particles within a detection volume in a predefined time period. The particle density may be the PM 2.5 value as defined by the corresponding National Air Quality Standard for Particulate Matter of the US Environmental Protection Agency. The signal strength of the self-mixing interference signals may be further used to determine an estimate of the particle size. The evaluator may, for example, comprise an ASIC which is adapted to evaluate the self-mixing interference signals generated by means of the laser and the compact optical device.

The laser sensor may further comprise an electrical driver. The electrical driver may be adapted to electrically drive the lasers such that the laser emits the measurement beam.

The laser sensor may alternatively or in addition comprise an interface by means of which control signals or electrical driving signals or detection signals can be exchanged with an external controller.

According to a further aspect a mobile communication device is provided. The mobile communication device comprises a laser sensor as described above. The laser sensor may comprise a dedicated evaluator or electrical driver. Alternatively or in addition at least a part of the functionalities of the electrical driver and the evaluator may be performed by means of associated circuitry of the mobile communication device. A first memory device and/or first processing device of the mobile communication device may interact with a second memory device and/or second processing device comprised by the laser sensor in order to exchange data or perform the functionalities of evaluator or electrical driver. The memory device or devices may be any physical device being arranged to store information especially digital information. The memory device may be especially selected out of the group solid-state memory or optical memory.

The processing device or devices may be any physical device being arranged to perform data processing especially processing of digital data. The processing device may be especially selected out of the group processor, microprocessor or application-specific integrated circuit (ASIC).

The mobile communication device comprises the detection window through which the measurement beam is emitted. The detection window may be a part of an outer surface of the mobile communication device. Integration of the laser sensor may be simplified by using a detection window which may be a part of or attached to the compact optical device. The size needed for integration of the laser sensor may be reduced by the integration of the detection window.

The laser sensor may be further be comprised by an air cleaner, by an air conditioning device or in a sensor box comprising one, two, three or more additional sensors.

It shall be understood that a preferred embodiment of the invention can also be any combination of the dependent claims with the respective independent claim.

Further advantageous embodiments are defined below.

These and other aspects of the invention will be apparent from and elucidated with reference to the embodiments described hereinafter.

### BRIEF DESCRIPTION OF THE DRAWINGS

In the drawings:

FIG. 1 shows a principal sketch of a conventional laser sensor module

FIG. 2 shows a principal sketch of a first laser sensor module

FIG. 3 shows a principal sketch of a second laser sensor module

FIG. 4 shows a principal sketch of a third laser sensor module

FIG. 5 shows a principal sketch of a fourth laser sensor module

FIG. 6 shows a principal sketch of a fifth laser sensor module

FIG. 7 shows a principal sketch of a sixth laser sensor module

FIG. 8 shows a principal sketch of a laser comprising a detector

FIG. 9 shows a principal sketch of a laser sensor

FIG. 10 shows a principal sketch of a mobile communication device

In the Figures, like numbers refer to like objects throughout. Objects in the Figures are not necessarily drawn to scale.

### DETAILED DESCRIPTION OF EMBODIMENTS

Various embodiments of the invention will now be described by means of the Figures.

Self-mixing interference is used for detecting movement of and distance to an object. Background information about self-mixing interference is described in “Laser diode self-mixing technique for sensing applications”, Giuliani, G.; Norgia, M.; Donati, S. & Bosch, T., Laser diode self-mixing technique for sensing applications, Journal of Optics A: Pure and Applied Optics, 2002, 4, S. 283-S. 294 which is incorporated by reference. Detection of movement of a fingertip relative to a sensor in an optical input device is described in detail in International Patent Application No. WO 02/37410.

The principle of self-mixing interference is discussed based on the examples presented in International Patent Application No. WO 02/37410. A diode laser having a laser cavity is provided for emitting a laser, or measuring, beam. At its upper side, the device is provided with a transparent window across which an object, for example a human finger, is moved. A lens is arranged between the diode laser and the window. This lens focuses the laser beam at or near the upper side of the transparent window. If an object is present at this position, it scatters the measuring beam. A part of the radiation of the measuring beam is scattered in the direction of the illumination beam and this part is converged by the lens on the emitting surface of the laser diode and re-enters the cavity of this laser. The radiation re-entering the cavity of the diode laser induces a variation in the gain of the laser and thus in the intensity of radiation emitted by the laser, and it is this phenomenon which is termed the self-mixing effect in a diode laser.

The change in intensity of the radiation emitted by the laser can be detected by a photo diode or a detector arranged to determine an impedance variation across the laser cavity. The diode or impedance detector converts the radiation variation into an electric signal, and electronic circuitry is provided for processing this electric signal.

The self-mixing interference signal may in case of particle detection, for example, be characterized by a short signal burst or a number of signal bursts. It may therefore be preferred to use a DC drive current in order to simplify signal detection and signal analysis. A modulated drive current may be used in order to determine the position and/or velocity of the particle, for example, by means of self-mixing interference signals which may be generated by reflection of laser light at bigger particles as described above. The velocity (and optionally distance) may be determined within one measurement or in a subsequent measurement step. It may therefore be possible or even beneficial to use a DC drive current in a first period in time in order to generate a particle measure of the intended particle size and a modulated drive current in order to determine the velocity of the particle flow. The distance, duration and the intensity of the signal may optionally be used to determine the particle size.

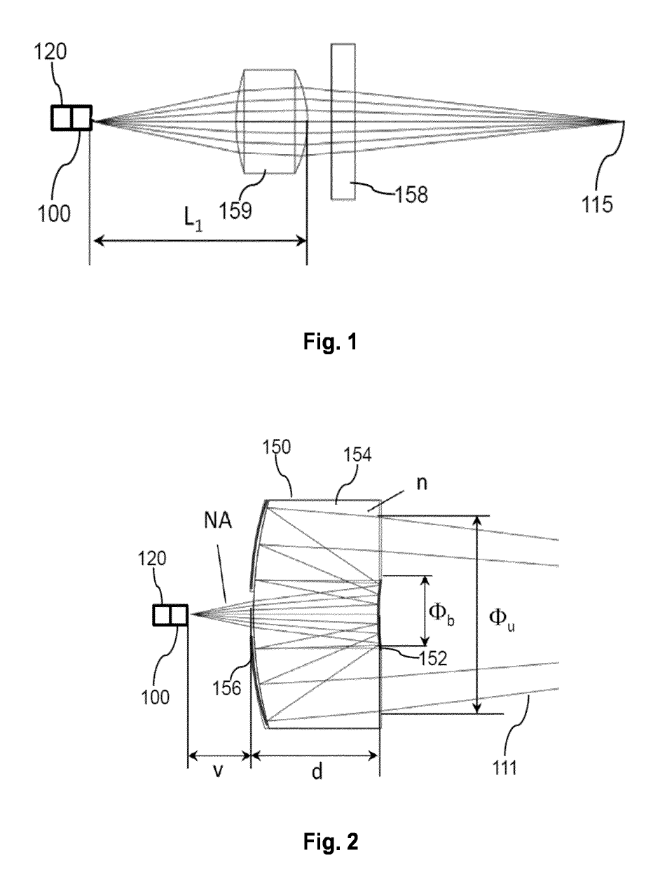

FIG. 1 shows a principal sketch of a conventional laser sensor module. The laser sensor module comprises a laser 100 and a detector 120 for determining changes of the impedance between the electrical contacts of the laser. The laser light emitted by the laser 100 is focused be means of a conventional biconvex lens 159 via a detection window 158 to a focus region 115.

FIG. 2 shows a principal sketch of a first laser sensor module. The laser sensor module comprises a laser 100 and a detector 120 for determining changes of the impedance between the electrical contacts of the laser which are caused by variations of the standing wave pattern in the laser cavity of the laser 100. The laser 100 is arranged to emit measurement beam 111 in direction of a compact optical device 150. The compact optical device 150 comprises an optical carrier 154 with a refractive index n. A convex mirror surface with a diameter Φ_{b} is placed on a backside side of the optical carrier 154 with respect to the laser 100. A concave mirror surface 156 is placed on an opposite front side of the optical carrier 154. The concave mirror surface 156 surrounds a circular entrance surface through which the measurement beam 111 emitted by the laser 100 can enter the optical carrier 154. The distance between the laser and the entrance surface is denoted ν. The measurement beam 111 entering the optical carrier is reflected and diverged by means of the convex mirror surface 152 to the concave mirror surface 156. A distance between the entrance surface and the convex mirror surface 152 is denoted d. The concave mirror surface 156 is arranged to focus the measurement beam 111 received from the convex mirror surface 152 to a focus region 115 (not shown). The measurement beam 111 reflected by the concave mirror surface 156 passes the backside of the transparent optical carrier 154 which defines an exit surface of the compact optical device 150. The measurement beam 111 has a diameter Φᵤ when passing the exit surface. The diameter Φ_{b} which can be used to determine the area blocked by means of the convex mirror surface 152 can be expressed by:

$${Φ}_{b} = 2 NA ( v + \frac{d}{n} ) ,$$

with ν the distance from laser to entrance surface, NA the coupling numerical aperture of the beam, d the thickness of the optical carrier 154 and n the refractive index of the material of the optical carrier 154. The total size of the laser sensor module can be reduced by means of the compact optical device 150 with a small coupling numerical aperture of, for example, NA=0.2.

The measurement beam 111 hits an object, for example, a particle in the focus region and a part of the measurement beam 111 is back scattered in the direction of the exit surface of the compact optical device 150. A part of the back scattered measurement beam 111 is blocked (absorbed or reflected) by a backside of the convex mirror surface 152. The measurement beam itself towards the focus region is also blocked by the concave mirror 152. A disadvantage of the compact optical device 150 may thus be that the convex mirror surface 152 at the backside of the optical carrier 154 (exit surface) blocks a part of the back scattered measurement beam 111 even if essentially no light of the measurement beam 111 gets lost prior to scattering at the object. The ratio of the square of the diameter Φ_{b} of the convex mirror surface 152 and the square of the diameter Φᵤ of the measurement beam 111 at the exit surface determine the intensity of scattered measurement beam re-entering the laser cavity of the laser 100. A sensitivity of the laser sensor module may therefore be decreased.

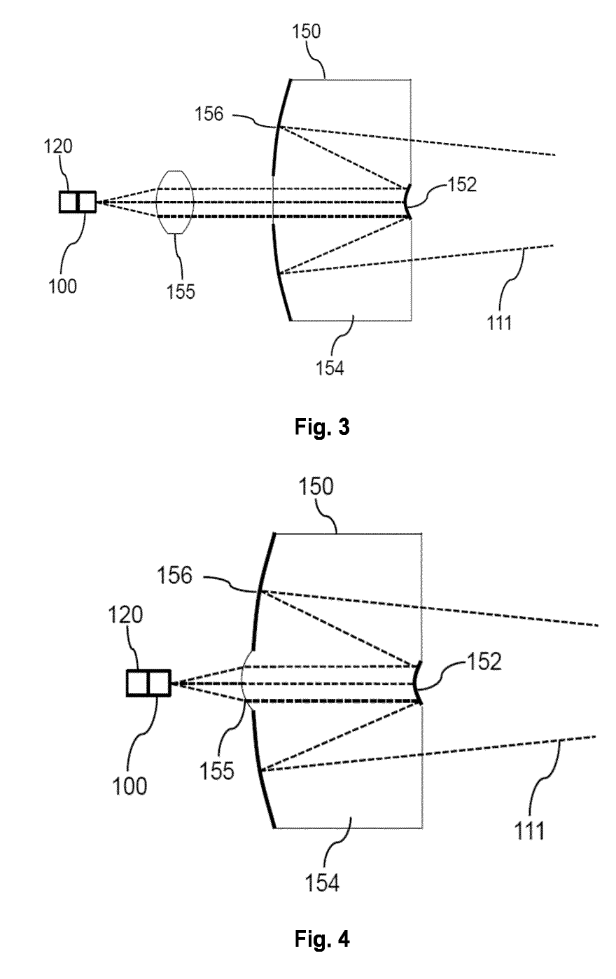

FIG. 3 shows a principal sketch of a second laser sensor module. The general configuration is nearly identical with the configuration discussed with respect to FIG. 2. A difference is that the detector 120 is a photo diode which is configured to measure variations of the optical standing wave within the laser cavity of the laser 100. A further difference is that an optical device 155, in this case a convex lens, is placed between the laser and the compact optical device 150 in order to converge the diverging measurement beam 111 emitted by the laser 100. The measurement beam 111 is converged such that an essentially parallel measurement beam 111 is reflected by the convex mirror surface 152. The curvature of the convex mirror surface 152 is increased in comparison to the convex mirror surface 152 discuss in FIG. 2 above. It is therefore possible to reduce the blocked area such that the sensitivity of the laser sensor module can be increased. Furthermore, the distance between the laser and the entrance surface of the compact optical device 150 can be reduced. The optical device 155 may comprise one, two, three or more optical components in order to enable a defined illumination of the convex mirror surface 152.

FIG. 4 shows a principal sketch of a third laser sensor module. The general configuration is very similar to the configuration discussed with respect to FIGS. 1 and 2. The detector 120 is in this case a photo diode integrated in a semiconductor layer structure of the laser 100. The optical device 155 is in this embodiment comprised by the compact optical device 150. A curvature of the entrance surface is increased such that the measurement beam 111 is converged and an essentially parallel measurement beam 111 is reflected at the convex mirror surface 152. Integrating the optical device 155 in the entrance surface of the compact optical device may further decrease the size of the laser sensor module and in addition decrease the area blocked by the convex mirror surface 152.

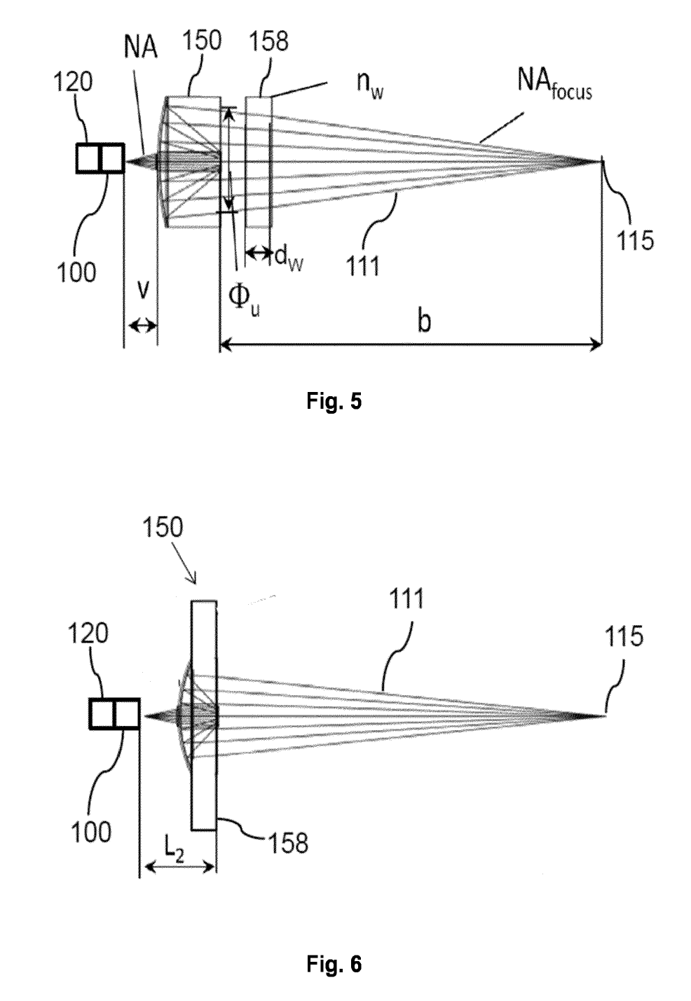

FIG. 5 shows a principal sketch of a fourth laser sensor module which is very similar as the laser sensor module described this respect to FIG. 4. The laser sensor module further comprises a detection window 158 with the thickness d_{w} and a refractive index n_{w}. The numerical aperture of the measurement beam focused to the focus region 115 is given by NA_{focus}. The diameter Φ_{b} of the convex mirror surface 152 blocking the scattered measurement beam 111 is in this case given by:

$${Φ}_{b} = 2 NA ( v + \frac{d}{n} ( 1 - v \frac{( n - 1 )}{R} ) )$$

with R the (paraxial) radius of the entrance surface.

In an example with the following data: v=0.6 mm, d=1.5 mm, n=1.5 and NA=0.19 the value of Φ_{b} without extra lens power is 0.61 mm (see equation above discussed with respect to FIG. 1). When lens power is added with (paraxial) R=0.35 mm the value of Φ_{b} will be reduced to 0.28 mm. Considering a diameter Φᵤ=1.5 mm of the measurement beam 111 at the exit surface, the ratio of blocked and beam area

$$\frac{{Φ}_{b}^{2}}{{Φ}_{u}^{2}}$$

is reduced from 16.5% to 3.5% in this example. This is almost a factor of 5.

FIG. 6 shows a principal sketch of a fifth laser sensor module. The general configuration is very similar to the configuration discussed with respect to FIG. 5. The detection window 158 is in this case an integrated part of the compact optical device 150. The detection window 158 comprises the optical carrier 154. Integration of the detection window 158 enables a very compact laser sensor module. A transparent protection layer may be attached to the backside of the detection window 158 in the direction of the focus region 115 such that the optical carrier and the convex mirror surface 152 are more scratch resistant.

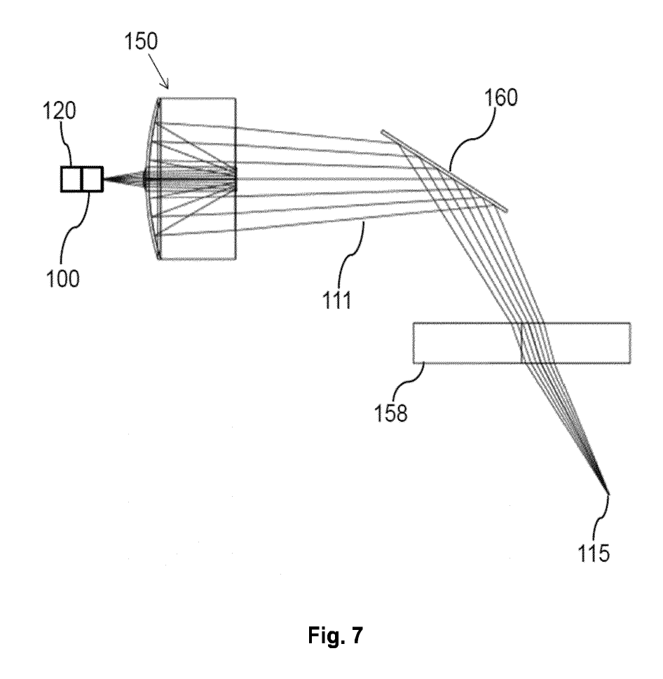

FIG. 7 shows a principal sketch of a sixth laser sensor module comprising an optical redirection device 160. The configuration of the laser 100, the detector 120 and the compact optical device 150 is essentially the same as discussed with respect to FIG. 4. The optical redirection device 160 is in this case a movable MEMS mirror which dynamically redirects the measurement beam 111 such that the focus region 115 moves and the detection volume is increased. Such a configuration may be especially beneficial in case of particle detection because the number of particles is increased by increasing the detection volume. It is therefore possible to decrease the detection time. The MEMS mirror is arranged between the compact optical device 150 and a detection window 158. For the diameter Φᵤ of the measurement beam 111 at the exit surface holds:

$${Φ}_{u} = 2 {NA}_{focus} ( b - {d}_{w} ( \frac{{n}_{w} - 1}{{n}_{w}} ) )$$

with NA_{focus} the NA in the focused beam, b the distance from lens to focus, d_{w} and n_{w} the thickness and refractive index of the detection window 158 as described above. The thickness of the detection window 158 d_{w} is typical 0.5 mm, the reflected index of the detection window 158 n_{w} is typical 1.5. The correction factor for the glass thickness is 0.17 mm, which is rather small such that the diameter Φᵤ can be approximately expressed by:

Φᵤ≈2NA_{focus}·b

A typical value for the focusing NA for a PM2.5 particle detector is:

NA_{focus}=0.10

For the situation with MEMS mirror the minimum value of b is approximately 7 mm. This means Φᵤ=1.4 mm. For the situation without MEMS mirror the minimum distance from detection window 158 to focus region 115 is approximately 2 mm, so the minimum value of b is then 2.5 mm. This results in Φᵤ=0.5 mm. The magnification m of the lens is the ratio of the focus NA and the coupling NA:

$$m = \frac{{NA}_{focus}}{NA}$$

For a conventional lens (see FIG. 1) the ratio between b and v is roughly proportional to the magnification. For NA_{focus}=0.10 and NA=0.19 the magnification is 1.9. For the compact optical device 150 the ratio between b and v can be more than a factor of 10. This means that by using the compact optical device 150 the building height can be reduced to around 3.6 mm for the case in of a MEMS mirror. For the situation without MEMS mirror it is approximately 1.3 mm.

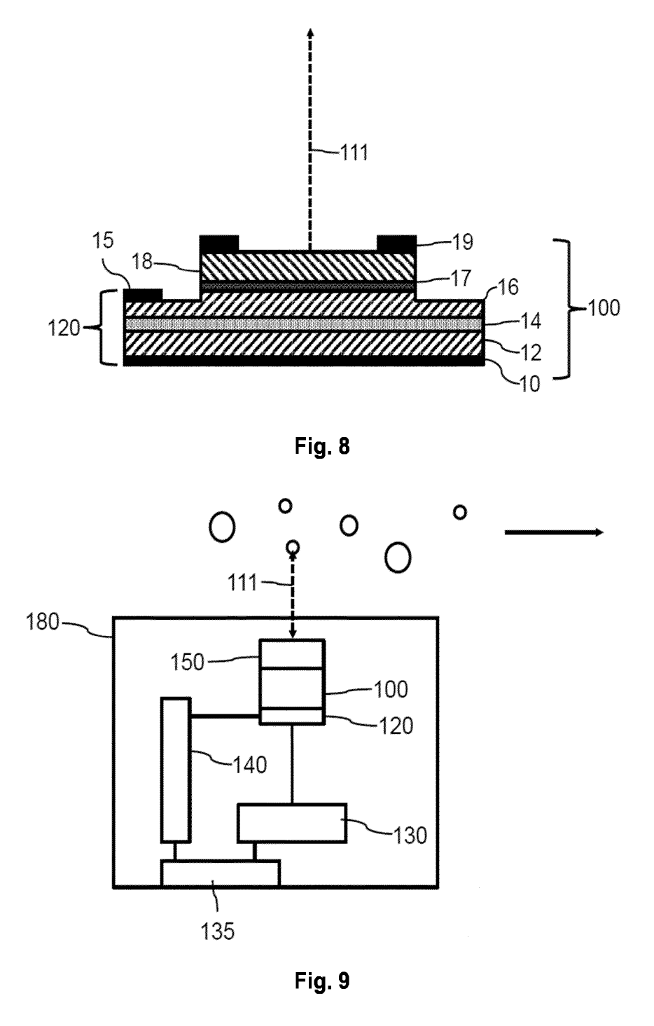

FIG. 8 shows a principal sketch of a laser 100 comprising a detector 120. The laser is a Vertical Cavity Surface Emitting Lasers (VCSEL) with integrated photodiode. The laser 100 is arranged on a semiconductor substrate 12 and comprises a bottom electrode 10. The laser further comprises a detection layer 14 comprising one or more photosensitive layers which are arranged to determine variations of the optical standing wave in the laser cavity of the laser 100. A photo current is measured by means of the bottom electrode 10 and detection electrode 15. The laser cavity of the VCSEL comprises a bottom Distributed Bragg Reflector (DBR) 16, an active layer 17, a top DBR 18 and a top electrode 19.

FIG. 9 shows a principal sketch of a laser sensor 180 which is configured as a particle sensor. The laser sensor 180 comprises a laser 100 and an integrated detector 120 (photodiode). The laser 100 emits the measurement beam 111. A compact optical device 150 is arranged between the laser 100 and a focus region of the measurement beam 111 (not shown). Self-mixing interference signals may be generated after reflection or scattering of the measurement beam 111 by a particle comprised by a particle flow, for example, parallel to a detection window 158 (not shown) of the particle sensor. The self-mixing interference signal is detected by the detector 120. The detected self-mixing interference signal is received and evaluated by means of an evaluator 140. The laser 111 is driven by means of an electrical driver 130. Electrical measurement results generated by means of the evaluator 140 as well as electrical power may be transferred by means of a common interface 135. Alternatively separate interfaces may be used to transfer electrical signals and electrical power. The evaluator 140 comprises a processing device and memory device (not shown) as described above.

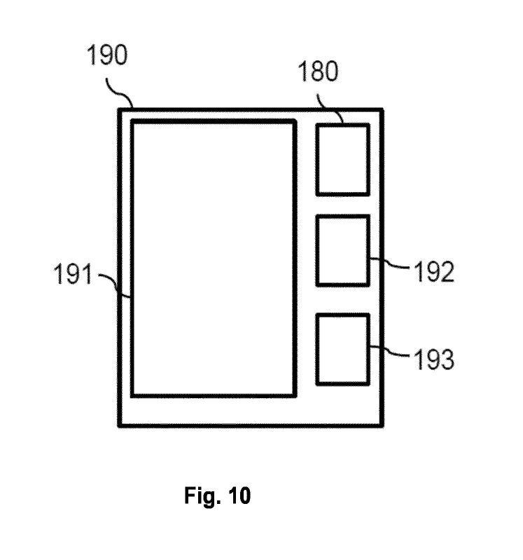

FIG. 10 shows a principal sketch of a mobile communication device 190 comprising a laser sensor 180. The mobile communication device 190 comprises a user interface 191, a processing device 192 and a main memory device 193. The main processing device 192 is connected with the main memory device 193 and with laser sensor module 100. The main processing device 192 comprises at least a part of the functionalities of evaluator 140 which are described above. The main processing device 192 stores data related to particle detection in the main memory device 193. In an alternative embodiment it may also be possible that the main processing device 192 and the main memory device 193 are only used to prepare or adapt data provided by means of the laser sensor 180 such that the data can be presented to a user of the mobile communication device 190 by means of user interface 191. The laser sensor 180 is powered by means of a power supply of the mobile communication device 190. The mobile communication device 190 may further comprise an orientation detection device (not shown). The orientation detection device may, for example, be adapted to determine the relative position of the mobile communication device 190 with respect to ground. The orientation detection device may be coupled with evaluator 140 or the main processing device in order to combine the data provided by means of the laser sensor 180 and data provided by means of the orientation detection device. Coupling of the orientation detection device and the laser sensor 180 may enable a more reliable detection of wind speed and particle density and may also provide information about wind direction.

It is a basic idea of the present invention to provide a compact self-mixing interference laser sensor module or laser sensor 180. A compact optical device 150 comprising at least a convex mirror surface 152 and a concave mirror surface 156 embedding an optical carrier may be used to reduce the building height of the laser sensor module or the laser sensor 180. An additional focusing device 155 may be used in order to reduce blocking of a measurement beam 111 caused by the arrangement of the at least convex mirror surface 152 in the optical detection path. The laser sensor module or laser sensor 180 may be used, for example, for particle detection, speed measurement, gesture control or distance measurements. The laser sensor module or laser sensor 180 may be comprised by other devices like, for example, air cleaner, vacuum cleaner, air conditioning devices, mobile devices such as mobile communication devices.

While the invention has been illustrated and described in detail in the drawings and the foregoing description, such illustration and description are to be considered illustrative or exemplary and not restrictive.

From reading the present disclosure, other modifications will be apparent to persons skilled in the art. Such modifications may involve other features which are already known in the art and which may be used instead of or in addition to features already described herein.

Variations to the disclosed embodiments can be understood and effected by those skilled in the art, from a study of the drawings, the disclosure and the appended claims. In the claims, the word “comprising” does not exclude other elements or steps, and the indefinite article “a” or “an” does not exclude a plurality of elements or steps. The mere fact that certain measures are recited in mutually different dependent claims does not indicate that a combination of these measures cannot be used to advantage.

Any reference signs in the claims should not be construed as limiting the scope thereof.

### LIST OF REFERENCE NUMERALS

10 bottom electrode
12 substrate
14 detection layer
15 detection electrode
16 bottom DBR
17 active layer
18 top DBR
19 top electrode
100 laser
111 measurement beam
115 focus region
120 detector
130 electrical driver
135 interface
140 evaluator
150 compact optical device
152 convex mirror surface
154 optical carrier
155 focusing device
156 concave mirror surface
158 detection window
159 conventional lens
160 optical redirection device
180 laser sensor
190 mobile communication device
191 user interface
192 main processing device
193 main memory device
ν distance from laser to entrance surface
NA coupling numerical aperture of the beam,
d thickness of the lens
n_{w} refractive index of the window
NA_{focus} NA in the focused beam
Φ_{b} diameter of blocked area
Φᵤ exit beam diameter

1. A laser sensor comprising:
at least one laser being adapted to emit a measurement beam,
an optical device arranged to focus the measurement beam on a focus region,
wherein the optical device comprises an optical carrier, the optical carrier comprising with a convex mirror surface on a first side and a concave mirror surface on a second side,
wherein the first second side is opposite the first side,
wherein the concave mirror surface comprises an entrance surface through which the measurement beam can enter the optical carrier,
wherein the optical device is arranged such that the measurement beam entering the optical carrier is reflected and diverged by means of the convex mirror surface to the concave mirror surface, and
wherein the concave mirror surface is arranged to focus the measurement beam received from the convex mirror surface on a focus region, and
a detector circuit arranged to determine at least a self-mixing interference signal of a first optical wave within a laser cavity of the laser.

2. The laser sensor according to claim 1, wherein a coupling numerical aperture NA of the optical device is in the range 0.15<NA<0.30

3. The laser sensor according to claim 1,
wherein the laser sensor further comprises a focusing device,
wherein the focusing devise is arranged to converge the measurement beam to the convex mirror surface of the optical device.

4. The laser sensor according to claim 3,
wherein the focusing device is positioned in the entrance surface of the optical device,
wherein the focusing device is arranged such that parallel light beams are received by the convex mirror surface.

5. The laser sensor according to claim 3,
wherein the laser, the focusing device, the convex mirror surface and the concave mirror surface are arranged to define an exit beam area of the optical device in a plane in which the convex mirror surface is positioned,
wherein the laser, the focusing device and the convex mirror surface are arranged such that more than 95% of the measurement beam is reflected to the concave mirror surface,
wherein the convex mirror surface covers less than 10% of the exit beam area.

6. The laser sensor according to claim 1, wherein a curvature of the convex mirror surface and a curvature of the concave mirror surface are arranged such that a distance d between the convex mirror surface and the concave mirror surface is 1 mm≤d≤2 mm.

7. The laser sensor according to claim 1,
wherein the laser sensor comprises an optical redirection device,
wherein the optical redirection device is arranged to dynamically change a position of the focus region.

8. The laser sensor according to claim 7, wherein the optical redirection device is a movable mirror.

9. The laser sensor according to claim 1,
wherein the laser sensor comprises a detection window,
wherein the detection window is arranged such that the measurement beam reaches the focus region after passing the detection window.

10. The laser sensor according to claim 1, wherein the detection window is at least partially arranged between the convex mirror surface and the concave mirror surface.

11. A laser apparatus comprising:
the laser sensor according to claim 1; and
an evaluator circuit,
wherein the evaluator circuit is arranged to receive detection signals generated by the detector in reaction to the determined self-mixing interference signals,
wherein the evaluator circuit is further arranged to determine at least one of a velocity component, distance or direction of movement of an object in the focus region.

12. A laser apparatus according to claim 10, wherein the evaluator circuit is arranged to determine a particle density based on the received detection signals in a predetermined time period.

13. The laser apparatus according to claim 12, wherein the particle density is the PM 2.5 value.

14. A mobile communication device comprising a laser apparatus according to claim 11,
wherein the mobile communication device comprises a user interface,
wherein the user interface is arranged to present data provided by means of the laser sensor.

15. A mobile communication device according to claim 14, wherein the detection window is a part of an outer surface of the mobile communication device.

16. A mobile communication device comprising a laser apparatus according to claim 12,
wherein the mobile communication device comprises a user interface,
wherein the user interface is arranged to present data provided by means of the laser sensor.
